(19) United States
(12) Patent Application Publication
(10) Pub. No.: US 2026/0310410 A1
(43) Pub. Date: Oct. 8, 2026

(54) METHOD AND APPARATUS FOR ACCUMULATING INFERRED DATA

(71) Applicant: Expedera, Inc., Santa Clara, CA (US)

(72) Inventors: John M. Wynne, Los Altos, CA (US); Athish Rahul Rao, San Jose, CA (US); Siyad Chih-Hua Ma, Palo Alto, CA (US); Sharad Vasantrao Chole, San Jose, CA (US); Shang-Tse Chuang, Taipei (TW)

(21) Appl. No.: 19/098,852

(22) Filed: Apr. 2, 2025

(51) Int. Cl. G06F 7/544; G06F 7/485; G06F 7/487

(52) U.S. Cl. CPC G06F 7/5443; G06F 7/485; G06F 7/4876

(57) ABSTRACT

Embodiments include systems and methods for accumulating inferred data, an exemplary system comprising at least one node of a neural network transmitting input data to a processor coupled to the node; the processor configured to convert data from an initially received format to an inferred format, the inferred format comprising: at least one representing the epoch of the one or more data, and twenty-four bits representing a value of the one or more data in signed mantissa. The processor is further coupled with at least one MAC unit with at least one multiplier, adder, and accumulator. The MAC unit performs at least one multiply operation and at least one add operation on the data. The processor is further configured to receive a result from the MAC unit, convert the result back to the initially received format, and transmit the result as a node output to the neural network.

### FIELD OF INVENTION

The present technology pertains to systems and methods for accumulating inferred data by a processing unit, and in particular, but not by limitation, for conversion for specialized data applications in neural networks.

The present disclosure includes a system for accumulating data in inferred data format, the system comprising at least one node of a neural network transmitting input data in an initially received format to a processor communicatively coupled to the at least one node; at least one multiply-accumulate unit communicatively coupled to the processor, the multiply-accumulate unit comprising at least one multiplier, at least one adder, and at least one accumulator, the multiply-accumulate unit configured to: perform at least one multiply operation on the one or more data in an unsigned format; convert one or more data from the unsigned format to an inferred format. The inferred format comprises at least one bit representing the epoch of the one or more data, and at least twenty-four bits representing a value of the one or more data in signed mantissa. The multiply-accumulate unit is further configured to perform at least one add operation on the one or more data in the inferred format and accumulate one or more results of the at least one multiply operation and the at least one add operation; and the processor is further configured to receive the one or more results from the multiply-accumulate unit, convert the result back to the initially received format, and transmit the result in the initially received format as a node output to the neural network.

In some embodiments, the initially received format comprises floating point format, and the processor further configured to convert the result into Institute of Electrical and Electronics Engineers Float (IEEE Float) format and transmit the IEEE Float result as the output to the neural network.

Alternatively, the initially received format comprises integer format, and the processor further configured to quantize the result and transmit the quantized result as the output to the neural network.

Generally, the epoch is incremented from zero to one when the result is greater than a value represented by the at least twenty-four bits of signed mantissa. When the epoch is incremented from zero to one, the value is increased by one byte in the multiply-accumulate unit. In some embodiments, when the epoch is incremented from zero to one, the least significant byte is discarded.

Some embodiments include a control system communicatively coupled with the processor and the at least one multiply-accumulate unit, the control system selecting the one or more data to be transmitted to the multiply-accumulate unit.

In some embodiments, the adder comprises an adder tree having multiple adder units to compute multiple sums.

Further embodiments of the disclosure include the methods of assembling, implementing, and using the system for accumulating inferred data as described herein.

### BRIEF DESCRIPTION OF THE DRAWINGS

In the description, for purposes of explanation and not limitation, specific details are set forth, such as particular embodiments, procedures, techniques, etc. to provide a thorough understanding of the present technology. However, it will be apparent to one skilled in the art that the present technology may be practiced in other embodiments that depart from these specific details.

The accompanying drawings, where like reference numerals refer to identical or functionally similar elements throughout the separate views, together with the detailed description below, are incorporated in and form part of the specification, and serve to further illustrate embodiments of concepts that include the claimed disclosure and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 diagrammatically illustrates an exemplary method for accumulating data using infer format.

FIG. 2 shows an exemplary deep neural network.

FIG. 3 diagrammatically illustrates an exemplary matrix processor that handles an element of a data vector.

FIG. 4 diagrammatically illustrates an exemplary MAC unit.

FIG. 5 diagrammatically illustrates an exemplary Infer format.

FIG. 6 depicts an implementation of an exemplary method for accumulating data using infer format.

### DETAILED DESCRIPTION

At present, many standard data formats exist for storing and manipulating data used for training Artificial Intelligence (AI). Examples include Bfloat, IEEE754, and Tensorfloat. These data formats were developed using standard Central Processing Unit (CPU) hardware and are intended to address tradeoffs between computational precision and range.

In one CPU, there are a limited number of bits that can be used to represent a number. Data formats trade off which bits exist for which parts of a number, and which represent a calculation, operation, or characteristic of the number. For example, some bits may indicate an exponent, a signed format, or a mantissa.

When training an inference engine for an AI, the inference engine must generally use the data format in which its data was trained. There is a need for optimal data training formats that make use of the internal inference formats for custom hardware built for AI. This may include mixing data formats in one or more of the same units, neurons, or nodes.

For an AI operation, addition and multiplication are two basic operations that must be performed in large quantities. In hardware, many logic gates are used in a series of frequent and sometimes redundant steps.

As an example, a traditional series of steps for adding a floating-point number includes: 1. Aligning the mantissas of the floating-point numbers, first by a subtraction to determine the difference in exponents, then a shift to align; 2. Taking the two’s complement for both inputs, each using a full adder; 3. Adding the mantissas together; 4. Taking the two’s complement again for the final format of the mantissa; 5. Determining the amount to shift the new exponent for realignment, generally using a decoder; 6. De-normalizing. These steps may also include detecting infinity or overflow conditions, as well as any rounding.

This sequence of steps is expensive for surface area and power consumption in both Field Programmable Gate Array (FPGA) and Application-Specific Integrated Circuit (ASIC) implementations.

An integer or fixed-point addition, by contrast, is only one operation – adding the two integers together, maintaining the two’s complement throughout. However, the range for integer addition is limited unless bits are added to accommodate data that would otherwise cause an overflow condition. Each subsequent add also requires additional bits to contain the result. By contrast, floating-point maintains the same, small memory footprint relative to integer format, making floating-point preferable for large data storage.

In a multiply operation, the mantissas generally do not need to be aligned or signed. However, multiply operations require the steps of adding and shifting once for each significant bit, as well as re-normalization at the end of the operation. Multiplication can thus be more expensive in CPU hardware in integer format compared to floating-point format, depending on the bits of precision required.

In sum, it is desired to have a CPU perform both floating point and integer arithmetic using the same hardware, as well as to alleviate performance issues. Traditional off-the-shelf components generally require duplicate hardware to handle multiple data formats.

Embodiments of the present disclosure utilize memory and programming with whichever data format is provided by the AI training model by converting that data format into an internal format that operates well for the given hardware during the operation. The returned data is quantized back into the requesting data’s domain. The systems and methods disclosed herein optimize power, performance, and surface area.

Exemplary embodiments use a specialized infer format that combines the properties of float and integer formats. This “infer” format keeps the required accuracy for computation on the CPU while maintaining speed and range, alleviating performance issues with floating-point calculations by substituting them with an equivalent representation.

An exemplary method of infer-format uses twenty-seven bits to encode a large (traditionally 48 bit) integer. According to the method, one or more epochs are used to shift entire bytes of data. As used herein, an “epoch” is represented as at least one bit in infer format to indicate a byte shift, or a shift in the data’s numerical value by 2³. In some embodiments, three bits are used to represent epochs, and twenty-four bits are used to represent a numerical value for an integer. Generally, there is no need to use exponent bits to shift data values. As the epoch is incremented, the least significant byte or bytes are discarded, and only the most significant twenty-four bits of signed mantissa are used. This allows the system to discard large portions of data that are unimportant to an inference operation.

Where infer format data is set to grow to a large number, hardware is set to prevent a shrink operation. For example, given a subtraction operation with two large numbers—for example, +1,000,000 - 1,000,000 + 1—in a typical floating-point system, the system would renormalize to the number 1. However, in some embodiments of the present disclosure, the system can be set to return zero by maintaining the epoch scale and not moving the epoch scale back down to zero.

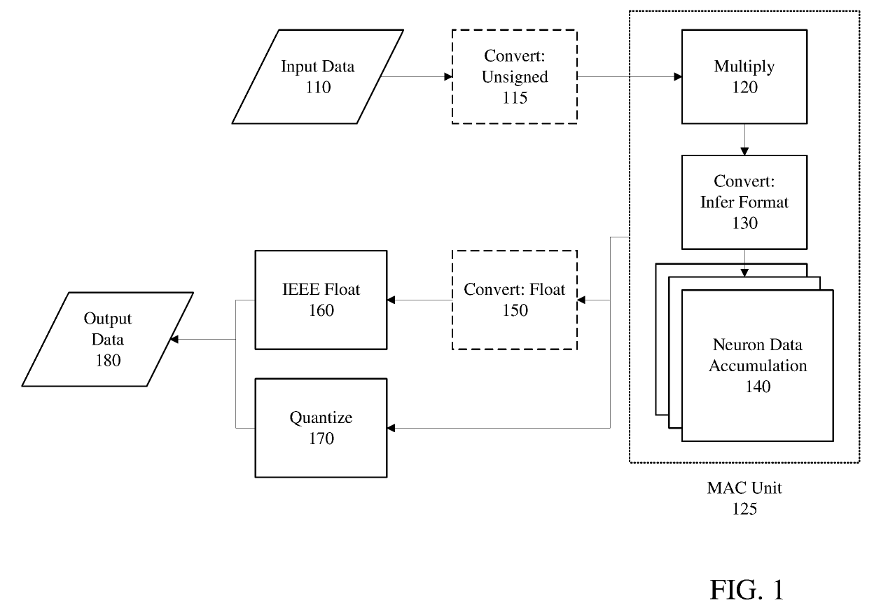

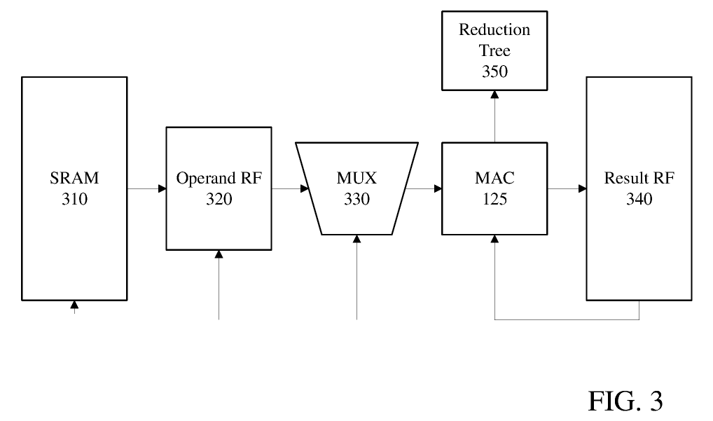

The data will generally also forego typical software operations such as denormalization, NaN (not a number), and any operation that maintains the unsigned mantissa. The mantissa will be kept as a signed number to prevent the hardware from performing redundant conversions. FIG. 1 diagrammatically illustrates an exemplary method for using the infer format. Input data 110 such as training data for an AI is received from a node of a neural network by a processor. If the data is received in floating-point format, it is converted by the processor into unsigned mantissa. In unsigned format, the data is received by a multiply-accumulate unit (MAC unit 125), which performs at least one multiply operation 120 on the data. The result is converted into infer format 130. The conversion to infer format 130 includes passing the values to registers comprising at least three bits of epoch and at least twenty-four bits of signed mantissa. The converted data, now in infer format, is passed to an adder, which first performs at least one addition operation, followed by data accumulation 140. In general, many such operations take place within the MAC unit 125. The MAC unit 125 will be described in further detail in FIG. 3 below.

The converted data remains in infer format while it is processed by the MAC unit 125, and is not re-converted to unsigned format, even through multiple operations. This eliminates the need to convert to unsigned format after two’s complement operations and thus the need for hardware to reconvert the data from two’s complement.

If the data was initially received in floating-point format, the data is then converted by the processor back to floating point 150. The data, now in floating point, is converted to Institute of Electrical and Electronics Engineers Float format (IEEE Float 160).

In alternative embodiments, where the data was initially received in integer format, the data remains in integer form. If the data was initially received in integer format rather than floating point, it is not converted to floating point after MAC unit 125 processing but is instead quantized 170 to maintain discrete values and discard unnecessary bits.

The data in IEEE Float 160 or integer quantized 170 format is then passed to the output 180, such as one or more nodes in a neural network. The output 180 is delivered in the same format in which the input 110 was received. In some embodiments, the data in IEEE Float 160 or integer quantized 170 format is stored in memory, such as Static Random Access Memory (SRAM). Other memory units, such as Double Data Rate Synchronous Dynamic Random-Access Memory (DDR SDRAM), can also be used.

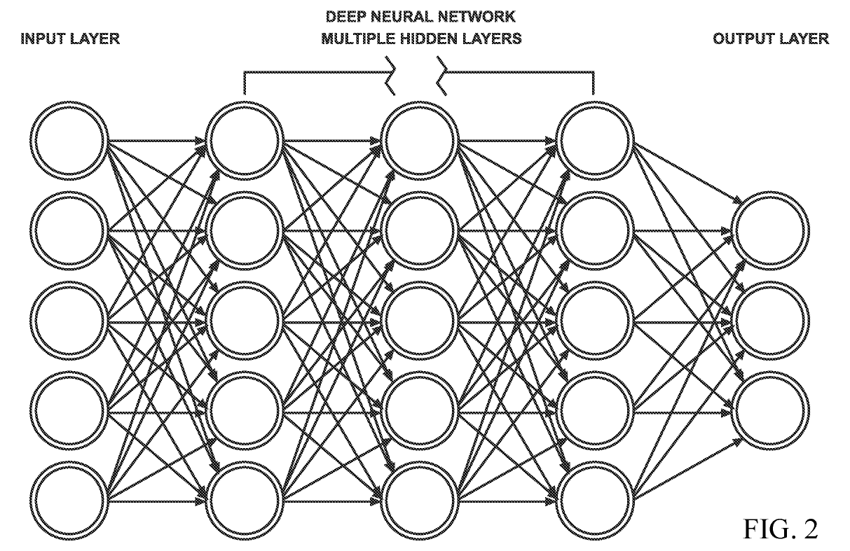

FIG. 2 shows an exemplary deep neural network.

Neural networks, also known as artificial neural networks (ANNs) or simulated neural networks (SNNs), are a subset of machine learning and are at the heart of deep learning algorithms. Their name and structure are inspired by the human brain, mimicking the way that biological neurons signal to one another. Artificial neural networks (ANNs) are comprised of node layers, comprising an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed along to the next layer of the network.

Neural networks rely on training data to learn and improve their accuracy over time. However, once these learning algorithms are fine-tuned for accuracy, they are powerful tools in computer science and artificial intelligence, allowing one to classify and cluster data at a high velocity. Tasks in speech recognition or image recognition can take minutes versus hours when compared to the manual identification by human experts.

In some exemplary embodiments, one should view each individual node as its own linear regression model, composed of input data, weights, a bias (or threshold), and an output. Once an input layer is determined, weights are assigned. These weights help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming the input of the next node. This process of passing data from one layer to the next layer defines this neural network as a feedforward network. Larger weights signify that particular variables are of greater importance to the decision or outcome.

According to some exemplary embodiments, deep neural networks are feedforward, meaning they flow in one direction only, from input to output. However, one can also train a model through backpropagation; that is, move in the opposite direction from output to input. Backpropagation allows one to calculate and attribute the error associated with each neuron, allowing one to adjust and fit the parameters of the model(s) appropriately.

In machine learning, backpropagation is an algorithm for training feedforward neural networks. Generalizations of backpropagation exist for other artificial neural networks (ANNs), and for functions generally. These classes of algorithms are all referred to generically as "backpropagation". In fitting a neural network, backpropagation computes the gradient of the loss function with respect to the weights of the network for a single input–output example, and does so efficiently, unlike a naive direct computation of the gradient with respect to each weight individually. This efficiency makes it feasible to use gradient methods for training multilayer networks, updating weights to minimize loss; gradient descent, or variants such as stochastic gradient descent, are used. The backpropagation algorithm works by computing the gradient of the loss function with respect to each weight by the chain rule, computing the gradient one layer at a time, iterating backward from the last layer to avoid redundant calculations of intermediate terms in the chain rule; this is an example of dynamic programming. The term backpropagation strictly refers only to the algorithm for computing the gradient, not how the gradient is used; however, the term is often used loosely to refer to the entire learning algorithm, including how the gradient is used, such as by stochastic gradient descent. Backpropagation generalizes the gradient computation in the delta rule, which is the single-layer version of backpropagation, and is in turn generalized by automatic differentiation, where backpropagation is a special case of reverse accumulation (or "reverse mode").

With respect to FIG. 2, according to some exemplary embodiments, the system produces an output, which in turn produces an outcome, which in turn produces an input. In some embodiments, the output may become the input.

According to the example of FIG. 2, one or more input data vectors are processed with a first weighted matrix to create a first intermediate data vector. The first intermediate data vector is processed with a second weighted matrix to create a second intermediate data vector. The process is repeated depending on the number of nodes in the neural network that may receive one or more data vectors.

In a forward propagation neural network, an output layer receives the final intermediate data vector and processes the vector to create an output. In some embodiments, the output data vector is used as intermediate data that is fed into additional artificial neural network layers such that complex hierarchical neural networks can be created.

Artificial intelligence supported by neural networks relies upon large amounts of computationally intensive matrix operations to learn using training data to adjust the weights in the weight matrices. Specialized processors for artificial intelligence are required, including specialized matrix processors.

FIG. 3 diagrammatically illustrates an exemplary matrix processor that handles an element of a data vector. The matrix processor circuit includes a local Static Random Access Memory (SRAM 310). Other memory units, such as Double Data Rate Synchronous Dynamic Random-Access Memory (DDR SDRAM) can be used. An input data vector having multiple elements or an entire row of weight values from a weight matrix can be read from or written to the SRAM 310 in a single memory cycle. The SRAM 310 is operatively coupled to an operand register file 320 for storing input data vectors and other vectors that may be used as operands during computations.

The SRAM 310 and operand register file 320 are operatively coupled to one or more multiplexors 330 that provide operand data to one or more MAC units 125.

Each element in the exemplary circuit of FIG. 3 is generally coupled to a local control system, not shown. The local control system selects between data stored within the SRAM 310, data in the operand register file 320, and any other input data to be provided to the MAC unit for data vector processing.

Outputs from the MAC units are stored in a result register file 340. In some embodiments, the results in the result register file 340 are combined with a reduction tree 350 to provide a single output. The reduction tree may be implemented outside the circuit depicted in FIG. 3. Results stored in the result register file 340 may also be used as input operands in subsequent data vector calculations. To handle these calculations, the MAC units 125 are coupled by a data path from the results register file 340. The local control system determines how the MAC units 125 select and process the input data.

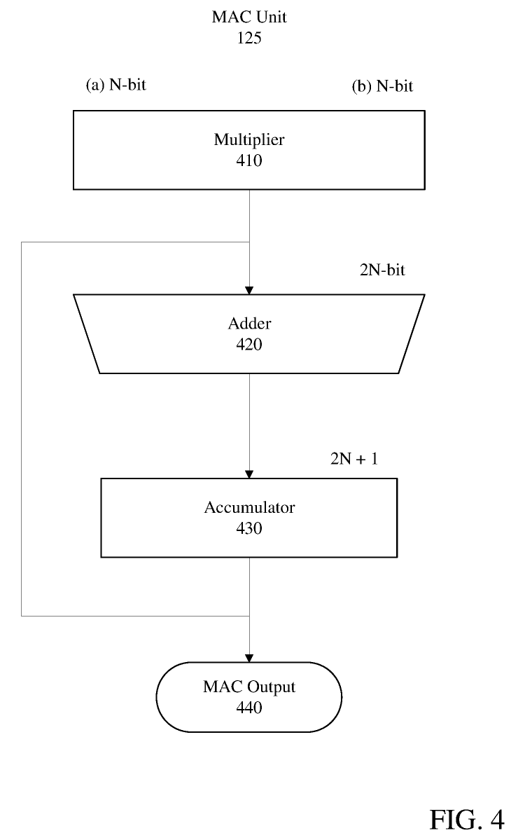

FIG. 4 diagrammatically illustrates an exemplary MAC unit 125. Two N-bit operand inputs are received by a multiplier 410 and are multiplied together. An adder 420 takes the sum of the product and any previously received product and stores the sum in the accumulator 430. In some embodiments, the adder 420 comprises an adder tree having multiple adder units to compute multiple sums.

For a multiply operation in infer format, two or more operands are received and formatted. In some embodiments, the operands are received in floating-point, in which case they are shifted to unsigned mantissa for multiplication. Where the operands are received in integer format, they are converted to unsigned format if needed. The operands are then multiplied.

A multiplication result is generated in unsigned format. The multiplication result is stored in memory in signed format. If the value no longer fits within the dedicated (for example twenty-four) bits, the epoch is incremented, and the result is shifted by one byte. The most significant twenty-four bits are used, and the least significant byte is discarded.

For an add operation in infer format, multiply results from the multiply operation are received and aligned by shifting to a byte boundary. Because the results are in two’s complement, sign bits are accounted for. Specialized shifting circuits such as barrel shifters are also not necessary. Once the results are aligned, the numbers are added.

The MAC outputs 440 of the accumulator are fed back to at least one input of the adder 420. On each clock cycle, the output of the multiplier 410 is added to the accumulator 430.

Each neuron or node in the neural network includes one MAC unit 125 having a multiplier 410, adder 420, and accumulator 430. In practice, a single neuron or node in a neural network has thousands of inputs and multiplies each input vector by a weight. The results are added, and an activation function is performed based on the accumulated results to determine the output.

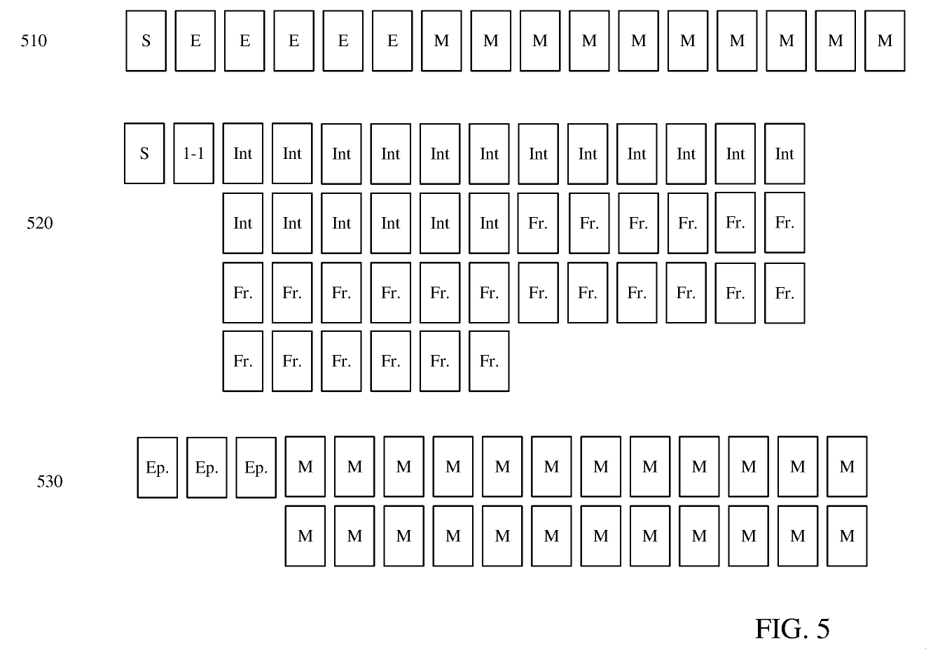

FIG. 5 diagrammatically illustrates an exemplary infer format. Data format IEEE FP16 210 is shown above; FP16 converted to integer 220 is shown at center; Infer format 230 is shown below. IEEE FP16 210 depicts 16 bits, with one bit indicating sign (“S”), five bits indicating exponent (“E”), and ten bits of mantissa (“M”). For IEEE FP16 210, the range is approximately 2⁻²⁴ to 2¹⁶, with ten bits of precision.

FP16 converted to integer 220 is 42 bits, with one bit for sign, one implied 1, sixteen integer (“Int.”), and twenty four for fraction (“Fr.”). It should be noted that the number of bits would grow with every addition operation.

By contrast, Infer-format 230 as exemplified here uses three bits of epoch (“Ep.”) and twenty-four bits of signed mantissa. The epoch bits indicate where, in a 72-bit region, the signed mantissa bits reside.

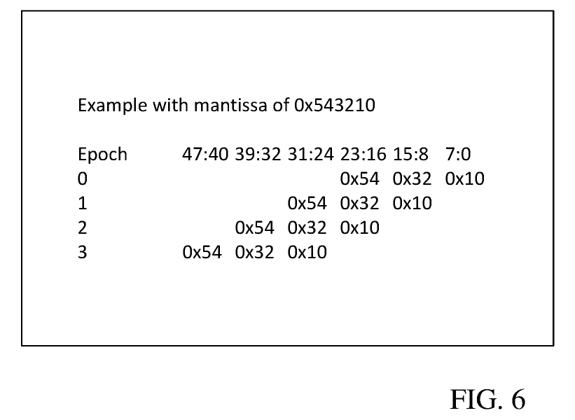

FIG. 6 depicts an implementation of an exemplary method using a mantissa of 0x543210. An integer value is represented by 48 bits, represented by eight-bit bytes (47:40 through 7:0). Three epoch shifts are depicted, as well as the null position (Epoch 0, 1, 2, 3).

In the null position (Epoch 0), the values representing 0x543210 occupy bytes 23:16,15:8, and 7:0. As the epoch is incremented, the values shift to the next set of bytes: 31:24, 23:16, and 15:8. Incrementing the epoch to 2 and 3 likewise shifts the values to the next byte. Notably, whole byte shifts are executed rather than single bit shifts.

Referring to an embodiment using three bits of epoch and twenty-four bits of signed mantissa, the example of FIG. 6 depicts an operation that allows for an increase in the data value and discarding of unnecessary bits. The example uses a mantissa of value 543210.

This value is processed by the MAC and produces a MAC output. If the result no longer fits in twenty-four bits, the epoch is increased by one, and the value fits in thirty-two bits. The least eight bits are discarded.

As more values are added and the value reaches a point at which thirty-two bits are insufficient, the epoch is increased from one to two, keeping the most significant twenty-four bits out of forty and discarding the least significant sixteen.

In each iteration, only the most significant twenty-four bits are maintained.

The foregoing detailed description includes references to the accompanying drawings, which form a part of the detailed description. The drawings show illustrations in accordance with exemplary embodiments. These example embodiments, which are also referred to herein as “examples,” are described in enough detail to enable those skilled in the art to practice the present subject matter.

The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents. In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description but is not intended to be exhaustive or limited to the invention in the form disclosed. Many modifications and variations will be apparent to those of ordinary skill in the art without departing from the scope and spirit of the invention. Exemplary embodiments were chosen and described to best explain the principles of the present technology and its practical application, and to enable others of ordinary skill in the art to understand the invention for various embodiments with various modifications as are suited to the particular use contemplated.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel or may be performed at different times.

The various embodiments described above, are presented as examples only, and not as a limitation. The descriptions are not intended to limit the scope of the present technology to the forms set forth herein. To the contrary, the present descriptions are intended to cover such alternatives, modifications, and equivalents as may be included within the spirit and scope of the present technology as appreciated by one of ordinary skill in the art. Thus, the breadth and scope of a preferred embodiment should not be limited by any of the above-described exemplary embodiments.

What is claimed is:

1. A system for accumulating data in inferred data format, the system comprising:
at least one node of a neural network transmitting input data in an initially received format to a processor communicatively coupled to the at least one node;
at least one multiply-accumulate unit communicatively coupled to the processor, the multiply-accumulate unit comprising at least one multiplier, at least one adder, and at least one accumulator, the multiply-accumulate unit configured to:
perform at least one multiply operation on the one or more data in an unsigned format;
convert one or more data from the unsigned format to an inferred format, the inferred format comprising:
at least one bit representing the epoch of the one or more data, and
at least twenty-four bits representing a value of the one or more data in signed mantissa; and
perform at least one add operation on the one or more data in the inferred format and accumulate one or more results of the at least one multiply operation and the at least one add operation; and
the processor further configured to receive the one or more results from the multiply-accumulate unit, convert the result back to the initially received format, and transmit the result in the initially received format as a node output to the neural network.

2. The system of claim 1, the initially received format comprising floating point format, and the processor further configured to convert the result into Institute of Electrical and Electronics Engineers Float (IEEE Float) format and transmit the IEEE Float result as the output to the neural network.

3. The system of claim 1, the initially received format comprising integer format, and the processor further configured to quantize the result and transmit the quantized result as the output to the neural network.

4. The system of claim 1, wherein the epoch is incremented from zero to one when the result is greater than a value represented by the at least twenty-four bits of signed mantissa.

5. The system of claim 4, wherein the value is increased by one byte in the multiply-accumulate unit when the epoch is incremented from zero to one.

6. The system of claim 5, wherein the least significant byte is discarded when the epoch bits are incremented from zero to one.

7. The system of claim 1, further comprising a control system communicatively coupled with the processor and the at least one multiply-accumulate unit, the control system selecting the one or more data to be transmitted to the multiply-accumulate unit.

8. The system of claim 1, the adder comprising an adder tree having multiple adder units to compute multiple sums.

9. A method for accumulating data in inferred data format, the system comprising:
transmitting input data in an initially received format from at least one node of a neural network to a processor communicatively coupled to the at least one node;
transmitting the input data to at least one multiply-accumulate unit communicatively coupled to the processor, the multiply-accumulate unit comprising at least one multiplier, at least one adder, and at least one accumulator, the multiply-accumulate performing the steps of:
performing at least one multiply operation on the one or more data in an unsigned format;
converting one or more data from the unsigned format to an inferred format, the inferred format comprising:
at least one bit representing the epoch of the one or more data, and
at least twenty-four bits representing a value of the one or more data in signed mantissa; and
performing at least one add operation on the one or more data in the inferred format and accumulate one or more results of the at least one multiply operation and the at least one add operation; and
receiving, by the processor, the one or more results from the multiply-accumulate unit;
converting the one or more results back to the initially received format; and
transmitting the one or more results in the initially received format as a node output to the neural network.

10. The method of claim 9, the initially received format comprising floating point format, and the processor further configured to convert the result into Institute of Electrical and Electronics Engineers Float (IEEE Float) format and transmit the IEEE Float result as the output to the neural network.

11. The method of claim 9, the initially received format comprising integer format, and the processor further configured to quantize the result and transmit the quantized result as the output to the neural network.

12. The method of claim 9, further comprising incrementing the epoch from zero to one when the result is greater than a value represented by the at least twenty-four bits of signed mantissa.

13. The method of claim 12, wherein the value is increased by one byte in the multiply-accumulate unit when the epoch is incremented from zero to one.

14. The method of claim 13, wherein the least significant byte is discarded when the epoch bits are incremented from zero to one.

15. The method of claim 9, further comprising selecting, by a control system communicatively coupled with the processor and the at least one multiply-accumulate unit, the one or more data to be transmitted to the multiply-accumulate unit.

16. The method of claim 9, further comprising performing multiple sums by the adder, the adder comprising an adder tree having multiple adder units.

17. A method for assembly and configuration of a system for accumulating data in inferred data format, the system comprising:
coupling at least one node of a neural network to a processor, the processor configured to receive input data in an initially received format from the at least one node;
coupling at least one multiply-accumulate unit to the processor, the multiply-accumulate unit comprising at least one multiplier, at least one adder, and at least one accumulator;
configuring the multiply-accumulate unit configured to:
perform at least one multiply operation on the one or more data in an unsigned format;
convert one or more data from the unsigned format to an inferred format, the inferred format comprising:
at least one bit representing the epoch of the one or more data, and
at least twenty-four bits representing a value of the one or more data in signed mantissa; and
perform at least one add operation on the one or more data in the inferred format and accumulate one or more results of the at least one multiply operation and the at least one add operation; and
further configuring the processor to receive the one or more results from the multiply-accumulate unit, convert the result back to the initially received format, and transmit the result in the initially received format as a node output to the neural network.

18. The method of claim 17, further comprising configuring the processor to convert the result into Institute of Electrical and Electronics Engineers Float (IEEE Float) format when the initially received format comprises floating point format; and to transmit the IEEE Float result as the output to the neural network.

19. The method of claim 17, further comprising configuring the processor to quantize the result when the initially received format comprises integer format; and to transmit the quantized result as the output to the neural network.

20. The method of claim 17, wherein the epoch is incremented from zero to one when the result is greater than a value represented by the at least twenty-four bits of signed mantissa, and the value is increased by one byte in the multiply-accumulate unit when the epoch is incremented from zero to one.
